(19) United States
(12) Patent Application Publication
(10) Pub. No.: US 2010/0256834 A1
(43) Pub. Date: Oct. 7, 2010

(54) VEHICLE CONTROL DEVICE AND VEHICLE CONTROL METHOD

(75) Inventors: Naoki Sakai, Kobe (JP); Ryuuji Nishimura, Kobe (JP); Kyohhei Morita, Kobe (JP); Kazumasa Kameda, Kobe (JP); Takahiro Koizumi, Kobe (JP); Tomohiko Nukano, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, HYOGO (JP)

(21) Appl. No.: 12/734,998

(22) PCT Filed: Nov. 28, 2008
(86) PCT No.: PCT/JP2008/071720

§ 371 Date: Jun. 9, 2010

(30) Foreign Application Priority Data
Dec. 14, 2007 (JP) 2007-324028

(51) Int. Cl. G06F 7/00

(52) U.S. Cl. 701/1

(57) ABSTRACT

Multiple speakers mounted to a vehicle, and a body ECU which includes a unit that identifies a driven part of the vehicle which is knocked based on input information from the multiple speakers, and a unit that drives the identified driven part. The body ECU identifies the driven part on the basis of the difference between input times of a sound input to the multiple speakers. The body ECU determines whether the user carries a portable device, and determines whether to permit or not the drive of the driven part.

### TECHNICAL FIELD

The present invention relates to a vehicle control device. Especially it relates to control techniques of a vehicle body using a plurality of sound input units.

### BACKGROUND ART

There has been conventionally known of techniques to detect vibration of a vehicle by using a speaker for a car audio mounted to the vehicle (For example, see Patent References 1 and 2).

A back electromotive force is generated by vibration of a voice coil caused by the vehicle vibration in a speaker device which makes sound by providing output signals of an audio amplifier circuit to the voice coil located in a magnetic field. The vehicle vibration can be detected by detecting the back electromotive force.

[Patent Reference 1] Japanese Patent Application Publication No. 2005-262944

[Patent Reference 2] Japanese Patent Application Publication No. 2007-137157

### DISCLOSURE OF THE INVENTION

### Problems to be Solved by the Invention

Techniques disclosed in Patent References 1 and 2 prevent a vehicular theft by detecting a vibration of the vehicle by speakers. However other efficient techniques using a vibration detected by speakers are not proposed.

The present invention is made in views of above circumstances, and the aim of the present invention is to provide a vehicle control device and a vehicle control method that improve a convenience of a user by using a sound input unit efficiently.

### Means for Solving the Problems

To achieve above aims, a vehicle control device of the present invention includes a plurality of sound input units located in different places in a vehicle; an identification unit that identifies a driven part of the vehicle which is knocked on the basis of input information of the plurality of sound input units; and a driving control unit that drives the identified driven part.

According to the present invention, when the driven part is knocked, the knock sound is input by the sound input unit, and the knocked part is identified. Therefore, it is possible to drive the driven part to be driven by knocking the driven part. This makes it possible to use the sound input unit efficiently, and improve the convenience of the user.

In the above vehicle control device, the identification unit may identify the driven part of the vehicle which is knocked by identifying a location of a sound source on the basis of a difference between input times of a sound from the sound source to the plurality of sound input units.

Therefore, it is possible to identify the driven part of the vehicle which is knocked with good accuracy.

In the above vehicle control device, it is possible to include a detection unit that detects a portable device that a user carries, and the driving control unit may permit a drive of the driven part on the basis of a detection result of the portable device.

Therefore, only the user who has a portable device can perform operations.

In the above vehicle control device, the driving control unit may permit the drive of the driven part for a predetermined period after a move of the portable device from an inside of the vehicle to an outside of the vehicle is detected.

Therefore, the user can perform operations only for the predetermined period after the user gets out of the vehicle.

In the above vehicle control device, the plurality of sound input units may be speakers in a vehicle interior.

It is possible to identify the knocked driven part of the vehicle by using existing speakers mounted to the vehicle.

A vehicle control method of the present invention includes a step that identifies a driven part of a vehicle which is knocked on the basis of input information of a plurality of sound input units located in different places of the vehicle; and a step that drives the identified driven part.

### EFFECTS OF THE INVENTION

According to the present invention, it is possible to use a sound input unit efficiently, and improve a convenience of a user.

### BRIEF DESCRIPTION OF DRAWINGS

FIG. 1 is a diagram illustrating a composition of an embodiment in accordance with a vehicle control device;

FIG. 2 is a diagram illustrating locations of speakers mounted to a vehicle;

FIG. 3 is a diagram illustrating a composition of a body ECU;

FIG. 4 is a diagram illustrating a hardware structure of a microcomputer;

FIG. 5A illustrates signal waveforms of back electromotive forces detected by speakers when a window glass of a driver's seat is knocked, and FIG. 5B is an enlarged view of a main part in FIG. 5A;

FIG. 6 is a diagram for explaining a method for identifying a knocked location;

FIG. 7 is a diagram for explaining a method for calculating a knocked location;

FIG. 8 is a flowchart illustrating a procedure of a microcomputer; and

FIG. 9 is a diagram illustrating a composition of the vehicle control device.

### BEST MODES FOR CARRYING OUT THE INVENTION

A description will now be given, with reference to accompanying drawings, of best embodiment of the present invention.

### Embodiment

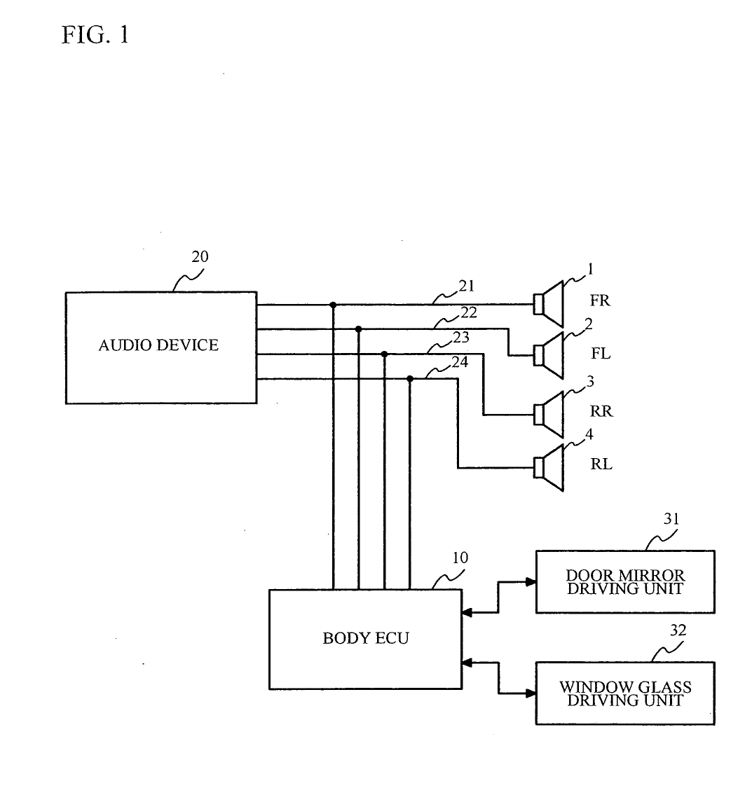

Referring to FIG. 1, a description will be given of a composition of the present embodiment.

As illustrated in FIG. 1, the present embodiment has a composition where a body ECU 10 is coupled with a signal line which couples an audio device 20 with multiple speakers 1, 2, 3 and 4 that are output units of the audio device.

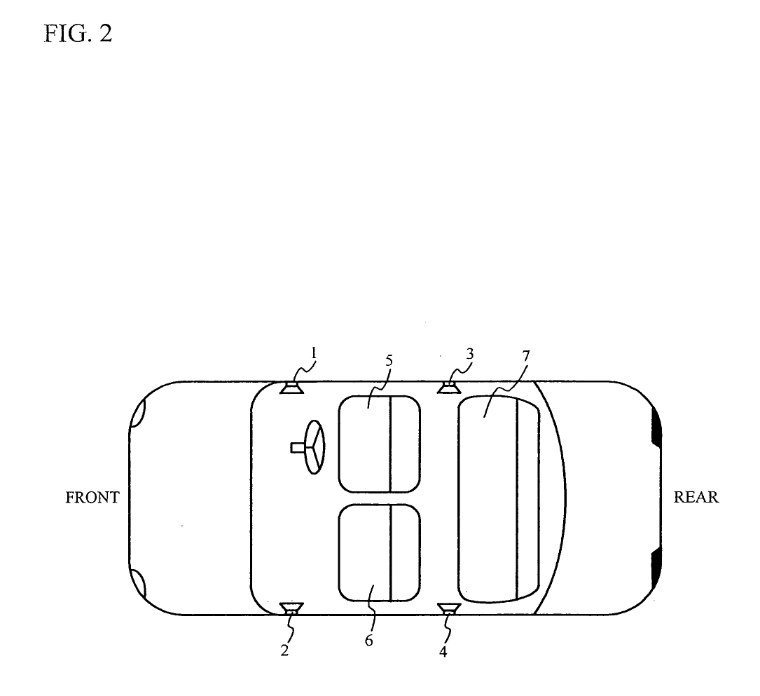

The multiple speakers (sound input units) are located in different places in the vehicle. It is desirable to spread these speakers to back and front and left and right. In the present embodiment, as illustrated in FIG. 2, a front speaker FR1 on a driver's seat 5 side that is located on a door to the driver's seat 5 and faces to a vehicle interior, a front speaker FL2 on a passenger's seat 6 side that is located in on a door to the passenger's seat 6 and faces to the vehicle interior, a rear speaker RR3 on the driver's seat 5 side that is located on a door to a rear seat 7 and faces to the vehicle interior, and a rear speaker RL4 on the passenger's seat 6 side that is located on a door to the rear seat 7 and faces to the vehicle interior are provided. Hereinafter, the front speaker FR1 on the driver's seat 5 side is referenced as a speaker 1, the front speaker FL2 on the passenger's seat 6 side is referenced as a speaker 2, the rear speaker RR3 on the driver's seat 5 side is referenced as a speaker 3, and the rear speaker RL4 on the passenger's seat 6 side is referenced as a speaker 4. Speakers mounted to the vehicle are not limited to these speakers. It is possible to provide a speaker in a front panel part of the vehicle, or a rear side of the rear seat 7.

The audio device 20 processes signals input from multiple audio sources such as a DVD player, a CD player, and a tuner, and generates audible signals to be played by the multiple speakers, and provide audible signals to speakers 1, 2, 3 and 4.

The body ECU 10 is coupled to a door mirror driving unit 31 with a signal line as illustrated in FIG. 1, closes and opens a door mirror unit and drives a mirror on the basis of the control of the body ECU 10. The body ECU 10 is coupled to a window glass driving unit 32 with the signal line, and drives a window glass up and down on the basis of the control of the body ECU 10.

The door mirror driving unit 31 is provided with an actuator (not illustrated) that closes and opens the door mirror unit, and an actuator that drives a mirror, and drives the door mirror unit according to the command from the body ECU 10.

The window glass driving unit 32 includes an actuator (not illustrated) that drives a window glass up and down, and drives the window glass according to the command from the body ECU 10.

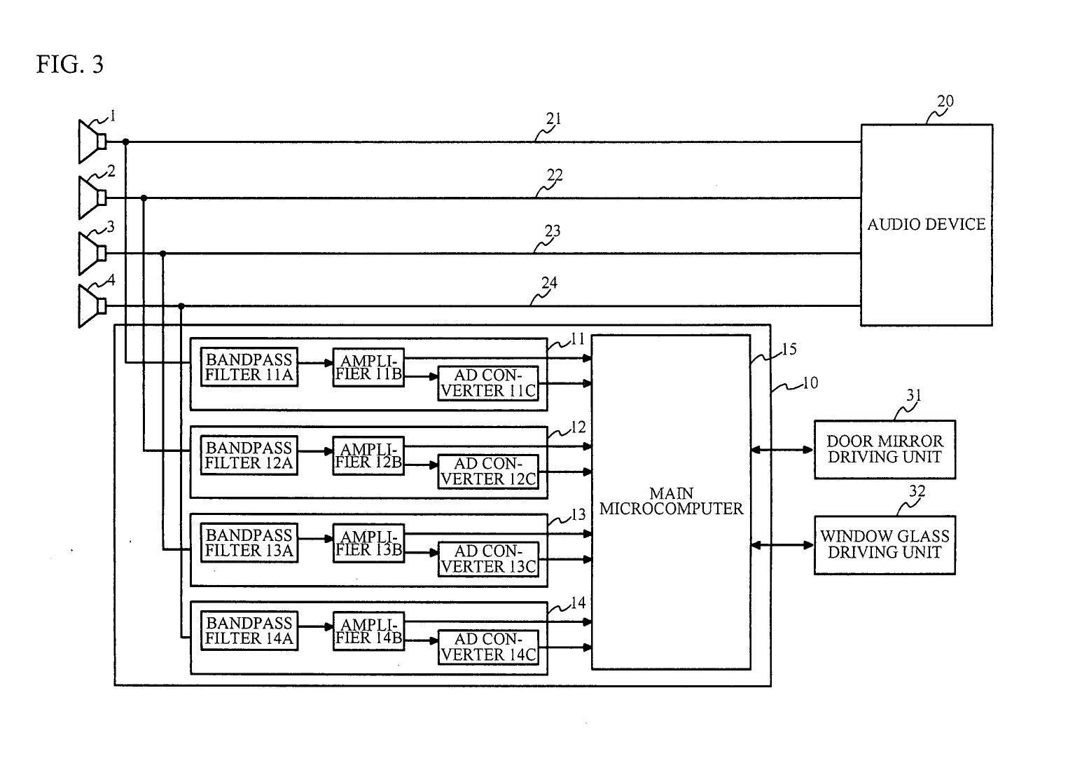

A composition of the body ECU 10 is illustrated in FIG. 3.

As illustrated in FIG. 3, the body ECU 10 is provided with signal processing units 11, 12, 13 and 14, and a main microcomputer 15.

The signal processing units 11, 12, 13 and 14 are respectively provided in accordance with speakers 1, 2, 3 and 4 mounted to the vehicle . The signal processing unit 11 is coupled to a signal line 21 which couples the audio device 20 with the speaker 1, the signal processing unit 12 is coupled to a signal line 22 which couples the audio device 20 with the speaker 2, the signal processing unit 13 is couple to a signal line 23 which couples the audio device 20 with the speaker 3, and the signal processing unit 14 is coupled with a signal line 24 which couples the audio device 20 with the speaker 4.

Signal processing units 11, 12, 13 and 14 have a same composition. Therefore, a description will be given of the signal processing unit 11 on behalf of other signal processing units.

The signal processing unit 11 includes a bandpass filter 11A, an amplifier 11B, and an AD converter 11C, receives a signal of back electromotive force generated in the speaker 1, and executes filtering, and amplification. An amplified signals that is AD-converted by the AD converter 11C and an amplified signal that is not AD-converted are output from the signal processing unit 11 to the main microcomputer 15.

The main microcomputer 15 receives signals processed by signal processing units 11, 12, 13 and 14, and identifies a driven part specified by the user on the basis of these signals. The method for identifying the driven part will be described later. The driven part includes the window glass and right and left door mirrors in the present embodiment.

When the main microcomputer 15 identifies the driven part specified by the user, it drives the identified driven part. For example, when the window glass is opened, the window glass is closed. When the window glass is closed, the window glass is opened. When the mirror of the door mirror unit is in the opened position (position for use) where the mirror faces to the rearward direction of the vehicle, the door mirror unit is driven to the closed position where the mirror faces to the vehicle interior side which is the right and left direction of the vehicle. When the door mirror unit is in the closed position, the door mirror unit is driven to the opened position.

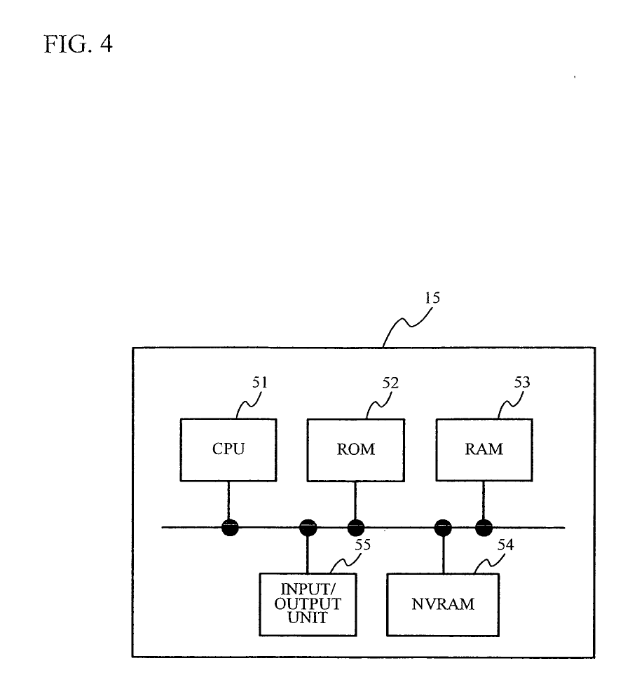

FIG. 4 illustrates a hardware structure of the main microcomputer 15.

The main microcomputer 15 includes a CPU 51, a ROM 52, a RAM 53, an NVRAM (Non Volatile RAM) 54, an input/output unit 55 and the like. The CPU 51 reads programs stored in the ROM 52, and executes calculation according to programs. The CPU 51 reads programs stored in the ROM 52, and executes a process for identifying the driven part specified by the user and a process for driving the identified driven part. These procedures will be described in detail later with reference to a flowchart. Data such as calculation results are written in the RAM 53. Data that are included in data written in the RAM 53 and are necessary to be stored during power-off are written into the NVRAM 54.

The body ECU 10 uses multiple speakers 1, 2, 3 and 4 mounted in the vehicle as a microphone, and identifies the driven part of the vehicle that the user specifies, by using a time difference between back electromotive forces generated in speaker 1, 2, 3 and 4. The user may specify the driven part by knocking the door mirror unit or the glass window lightly, for example.

When the driven part is knocked, the back electromotive force is generated by vibration of a voice coil located in the magnetic field in speakers 1, 2, 3 and 4.

As the knock sound generated by user's knock of the driven part becomes a sonic wave and is carried in the air, the back electromotive force is fastest generated in the speaker which is nearest to the driven part which is knocked, and the back electromotive force is last generated in the speaker which is farthest from the driven part which is knocked. The difference between arrival times of the knock sound at speakers shows up as the difference between generated times of back electromotive forces in speakers.

In the present embodiment, the driven part of the vehicle that the user specifies is identified by using these characteristics.

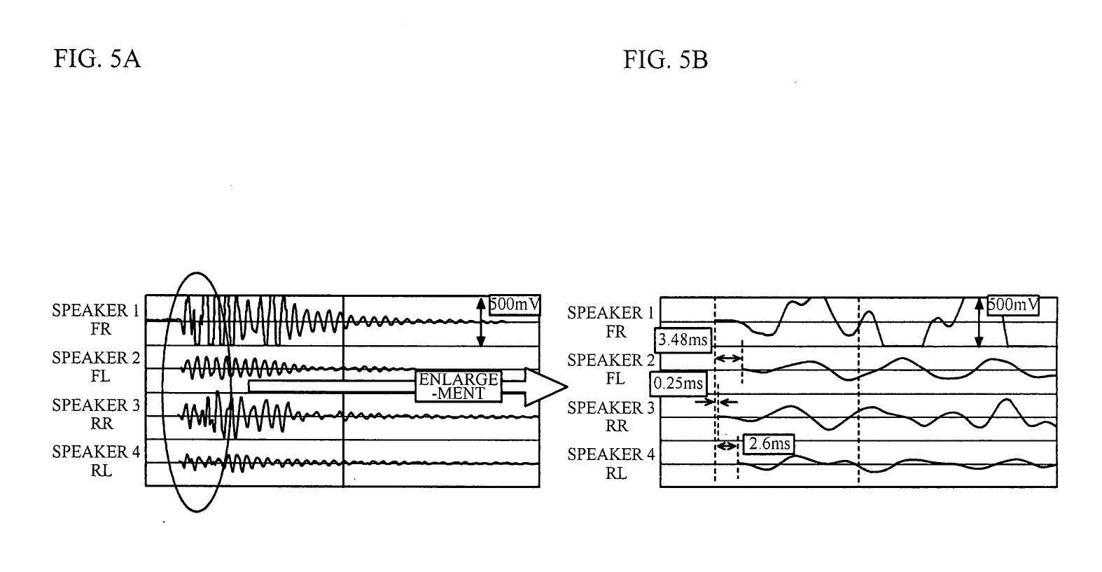

FIG. 5A illustrates back electromotive forces generated in speakers 1, 2, 3 and 4 when the window glass 60 of the driver's seat 5 is knocked. FIG. 5B enlarges waveforms at the point when back electromotive forces are generated in speakers 1, 2, 3 and 4.

As illustrated in FIG. 5B, the back electromotive force is generated first in the speaker 1 which is nearest to the window glass 60 of the driver's seat 5 which is knocked. The back electromotive force is generated secondarily in the speaker 3 on the right side of the rear seat which is second nearest to the window glass of the driver's seat 5. Then, back electromotive forces are generated in order of the speaker 4 on the left side of the rear seat and the speaker 2 of the passenger seat, according to the distance from the window glass 60 of the driver's seat 5.

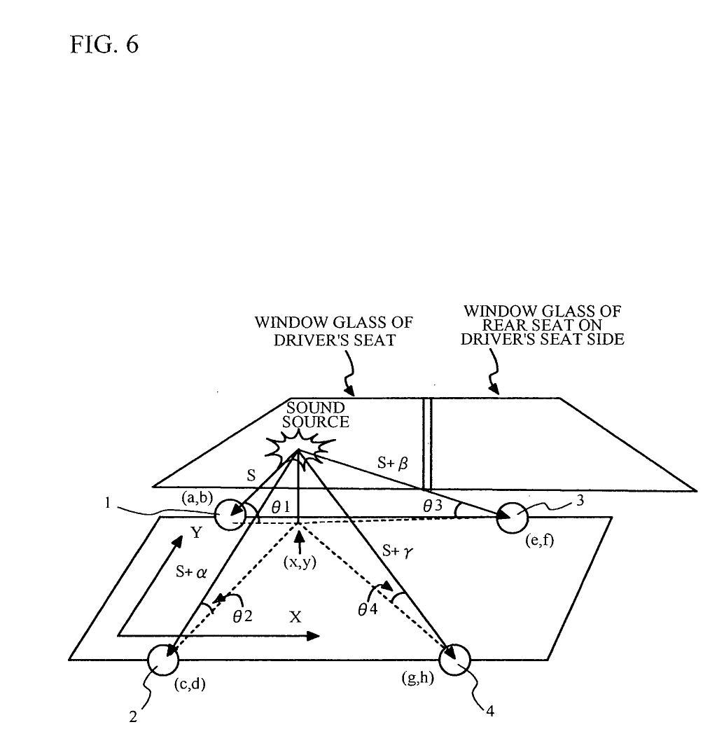

Referring to FIG. 6, a description will be given of a method for identifying a driven part which is knocked.

Hereinafter, a driven part which is knocked is referred to as a sound source because the knock sound is generated by the knock. A distance (unit: m) between the sound source and the speaker which is nearest to the sound source is defined as S. Distances between the sound source and other speakers can be expressed with a time difference from the generated time of the back electromotive force in the nearest speaker.

For example, suppose that the window glass of the driver's seat 5 is knocked as illustrated in FIG. 6. In this case, the speaker which is nearest to the sound source is the speaker 1. When a time difference between the time when the back electromotive force is generated in the speaker 1 and the time when the back electromotive force is generated in the speaker 2 is defined as U, the distance (unit: m) between the sound source and the speaker 2 is expressed as S+U (331.5+0.6×t). “t” is a temperature (° C.) of the vehicle interior. When U (331.5+0.6×t) is expressed with α, a distance between the sound source and the speaker 2 is expressed as S+α.

In the same manner, when a time difference between the time when the back electromotive force is generated in the speaker 1 and the time when the back electromotive force is generated in the speaker 3 is defined as V, a distance (unit: m) between the sound source and the speaker 3 is expressed as S+V (331.5+0.6×t). When V (331.5+0.6×t) is expressed with β, the distance between the sound source and the speaker 3 is expressed as S+β.

In the same manner, when a time difference between the time when the back electromotive force is generated in the speaker 1 and the time when the back electromotive force is generated in the speaker 4 is defined as W, a distance (unit: m) between the sound source and the speaker 4 is expressed as S+W (331.5+0.6×t). When W (331.5+0.6×t) is expressed with γ, the distance between the sound source and the speaker 4 is expressed as S+γ.

Distances on an XY plane where four speakers 1, 2, 3 and 4 exist are calculated by multiplying calculated distances by a correction coefficient. Suppose that four speakers 1, 2, 3 and 4 mounted in the vehicle are on the same plane (defined as the XY plane), and define angles (sharp angle) between lines connecting a representative point on each window glass to speakers 1, 2, 3 and 4 and the XY plane as θ1, θ2, θ3 and θ4. Distances between the sound source and speakers 1, 2, 3 and 4 on the XY plane are calculated by multiplying distances between the sound source and speakers S, S+α, S+β and S+γ by cos θ1, cos θ2, cos θ3, and cos θ4 respectively. The correction coefficient cos θ is stored in a memory such as the RAM 53 in accordance with each window glass or each door mirror. The middle position or barycentric position can be used as the representative point of the window glass.

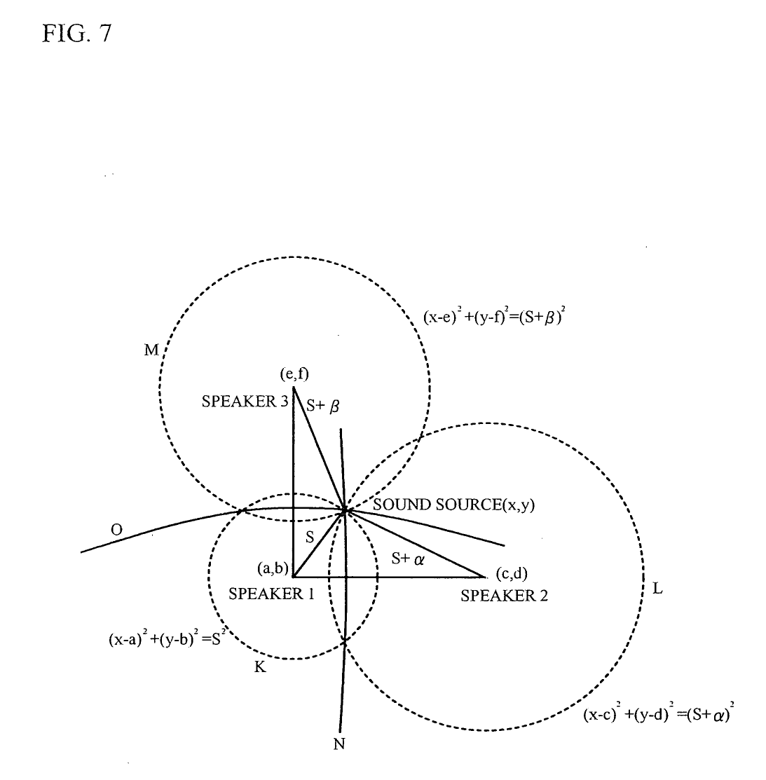

After distances between the sound source and speakers 1, 2, 3 and 4 on the XY plane are calculated, the location of the sound source is identified by calculating an intersection of three circles as illustrated in FIG. 7.

For instance, the equation of a circle K passing through the speaker 1 and the sound source is expressed by following formula (1).

(x−a)²+(y−b)²=S² (1)

The coordinate position of the sound source on the XY plane is defined as (x, y), and the coordinate position of the speaker 1 on the XY plane is defined as (a, b).

In the same manner, the equation of a circle L passing through the speaker 2 and the sound source is expressed by following formula (2).

(x−c)²+(y−d)²=(S+α)² (2)

The coordinate position of the speaker 2 on the XY plane is defined as (c, d).

In the same manner, the equation of a circle M passing through the speaker 3 and the sound source is expressed by following formula (3).

(x−e)²(y−f)²=(S+β)² (3)

The coordinate position of the speaker 2 on the XY plane is defined as (e, f).

As illustrated in FIG. 7, the sound source exists at the position where the locus of the intersection of the circle K with the circle L intersects with the locus of the intersection of the circle K with the circle M.

As the distance between the representative point of each window glass and the XY plane is preliminarily known, it is possible to determine the driven part which is knocked with good accuracy by calculating the coordinate position of the sound source on the XY plane.

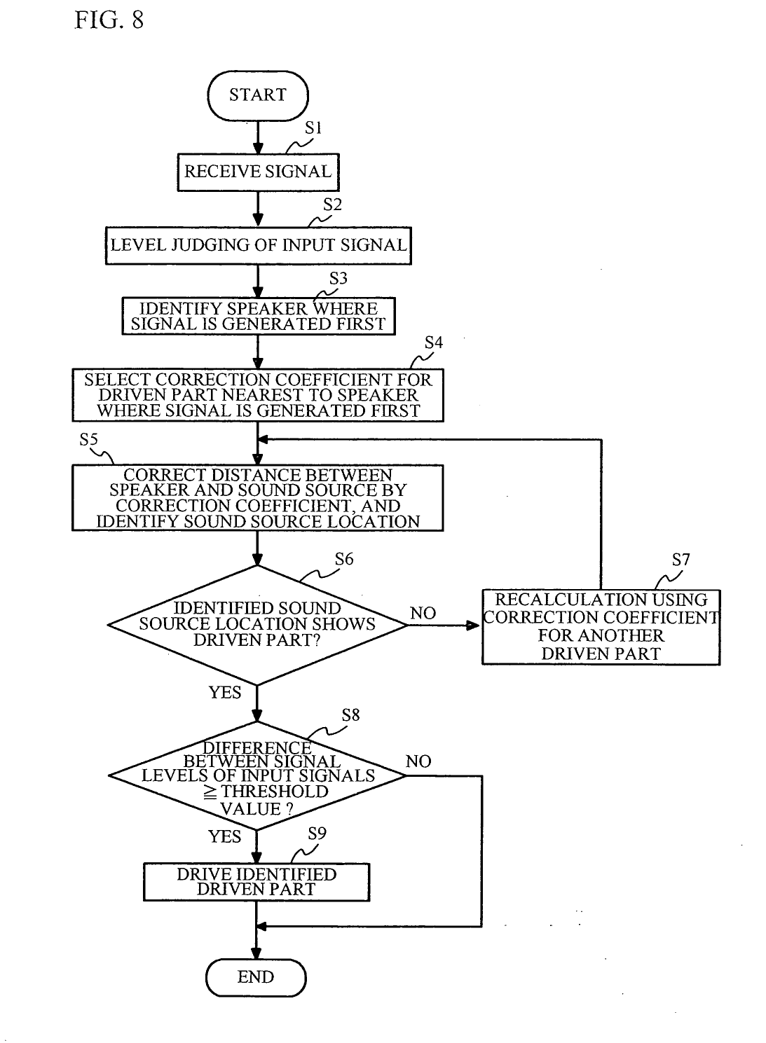

Referring to a flowchart illustrated in FIG. 8, the processing procedure of the body ECU 10 will be described.

The body ECU 10 receives signals of back electromotive forces generated in four speaker 1, 2, 3 and 4 mounted in the vehicle (step S1), and executes a signal processing by signal processing units 11, 12, 13 and 14. Processes such as filtering, amplification, and AD conversion are executed, and processed signals are input to the main microcomputer 15 of the body ECU 10.

Then, the main microcomputer 15 judges levels of input signals (step S2), and identifies the speaker where the signal is generated first (step S3).

Then, the main microcomputer 15 selects a correction coefficient for the driven part which is nearest to the speaker where the signal is generated first (step S4). For example, when the speaker 1 is a speaker that detects the signal first, the correction coefficient for the window glass on the driver's seat 5 side is selected.

The main microcomputer 15 multiplies the variable representing distances between the sound source and speakers by the correction coefficient, and converts them to distances on the XY plane where speakers exist. The location of the sound source on the XY plane is identified by using formulas (1), (2) and (3) (step S5).

As the distance between the XY plane and the driven part is preliminarily known, the main microcomputer 15 determines whether the calculated sound source location shows the location of the window glass (step S6).

When the sound source location does not show the driven part for which the correction coefficient is selected in the step S4 (step S6/NO), the sound source location is recalculated by using the correction coefficient for another driven part (step S7). For example, when the sound source location is not the window glass, the recalculation is performed by using the correction coefficient for the door mirror unit.

When the sound source location shows the driven part for which the correction coefficient is selected in the step S4 (step S6/YES), it is determined whether the difference between signal levels of signals input from speakers is greater than or equal to the threshold value (step S8).

When the window glass is knocked, there is a big difference between the signal level of back electromotive force detected by the speaker which is nearest to the knocked window glass and signal levels of back electromotive forces detected by other speakers. It is possible to increase the determination accuracy to determine whether the window glass or the door mirror is knocked or not by judging the difference between signal levels detected by speakers.

When the difference between signal levels of signals input from speakers is less than the threshold value (step S8/NO), the main microcomputer 15 ends the process.

When the difference between signal levels of signals input from speakers is greater than or equal to the threshold value (step S8/YES), the main microcomputer 15 drives the identified driven unit (step S9).

According to the present embodiment, when the driven part is knocked, the knock sound is input to speakers, and the driven part which is knocked is identified. Therefore, it is possible to drive the driven part to be driven by knocking it. This makes it to use speakers 1, 2, 3 and 4 mounted to the vehicle efficiently, and improve the convenience of the user.

### Second Embodiment

Referring to the accompanying drawing, a description will be given of the second embodiment in accordance with the present invention.

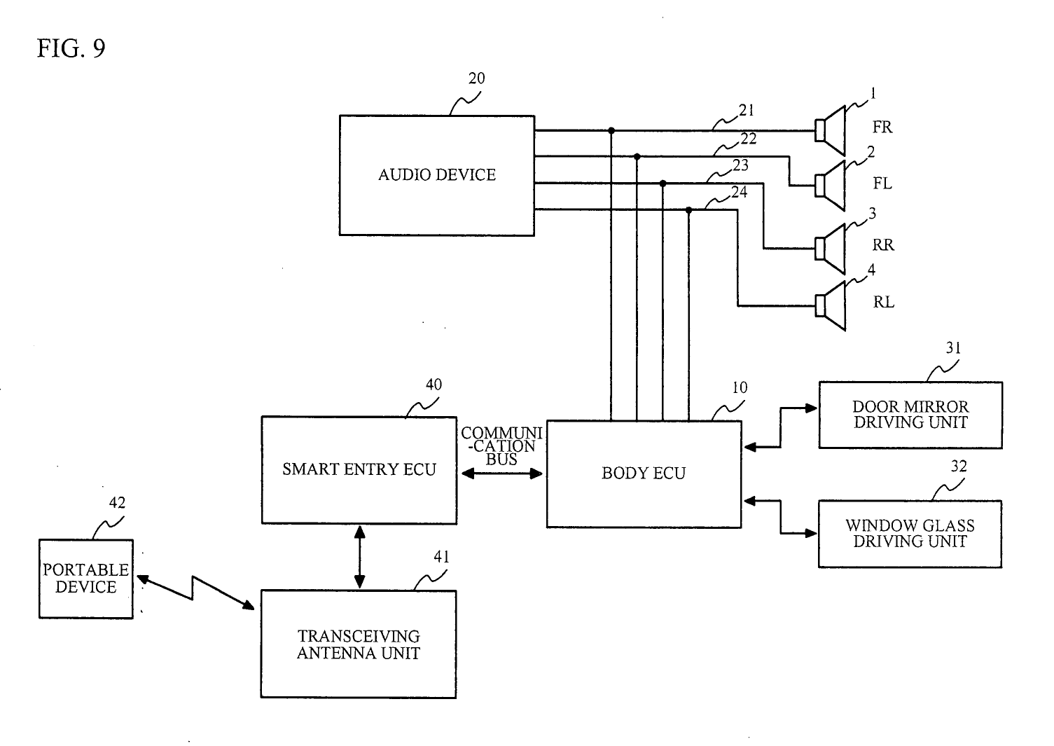

In the present embodiment, as illustrated in FIG. 9, the body ECU 10 described above is coupled with a smart entry ECU 40 by a communication bus. The body ECU 10 communicates with the smart entry ECU 40 with a protocol such as CAN (Controller Area Network).

The smart entry ECU 40 includes a transceiving antenna unit 41, detects radio waves from a portable device 42 that the user carries, and determines whether the user is outside the vehicle, or inside the vehicle. When the user is outside the vehicle, it is determined whether the user is close to the vehicle. The determination result is noticed to the body ECU 10.

The body ECU 10 obtains information from the smart entry ECU 40, and determines whether the user is close to the vehicle when the knock sound is detected. When it is determined that the user is not close to the vehicle, the driven part is not driven based on the detected knock sound. When it is detected that the user moves from the inside of the vehicle to the outside of the vehicle, the detection of the knock sound in the driven part and the driving of the identified driven part are executed according to the flowchart illustrated in FIG. 8 only in the predetermined period after the user's move to the outside of the vehicle.

According to the present invention, as the body ECU 10 obtains the information from the smart entry ECU 40, and performs the control, only the user of the vehicle can execute operations. It is possible to permit the operation based on the knock of the driven part only for the predetermined period after the user moves outside the vehicle.

Although detail descriptions are given of a preferred embodiment of the present invention, the present invention is not limited to the specifically described embodiment and variation, but other embodiments and variations may be made without departing from the scope of the present invention.

For example, in above embodiments, the knocked window glass or the knocked door mirror is driven. However, it is possible to detect the knocked location by back electromotive forces generated in speakers, and control the lighting-on/off of the headlight or indicator by the knock of a headlight or indicator. It is possible to turn on the hazard lamp by changing the number of knocks of the headlight. It is also possible to detect the knocked location by back electromotive forces generated in speakers, and control the opening/closing of the trunk or the bonnet by the knock of the trunk or the bonnet.

In the above embodiment, multiple speakers for audio are used as multiple sound input units, but it is possible to provide multiple dedicated microphones. It is desirable to provide more than three (four, more preferably) sound input units because it is desirable that multiple sound input units are spread to back and front and left and right to identify the sound source location with high accuracy.

1. A vehicle control device comprising:
a plurality of sound input units located in different places in a vehicle;
an identification unit that identifies a driven part of the vehicle which is knocked on the basis of input information of the plurality of sound input units; and
a driving control unit that drives the identified driven part.

2. The vehicle control device according to claim 1, wherein the identification unit identifies the driven part of the vehicle which is knocked by identifying a location of a sound source on the basis of a difference between input times of a sound from the sound source to the plurality of sound input units.

3. The vehicle control device according to claim 1, comprising a detection unit that detects a portable device that a user carries, the driving control unit permitting a drive of the driven part on the basis of a detection result of the portable device.

4. The vehicle control device according to claim 3, wherein the driving control unit permits the drive of the driven part for a predetermined period after a move of the portable device from an inside of the vehicle to an outside of the vehicle is detected.

5. The vehicle control device according to claim 1, wherein the plurality of sound input units are speakers in a vehicle interior.

6. A vehicle control method comprising:
a step that identifies a driven part of a vehicle which is knocked on the basis of input information of a plurality of sound input units located in different places of the vehicle; and
a step that drives the identified driven part.
